(19) United States
(12) Patent Application Publication
(10) Pub. No.: US 2015/0156057 A1
(43) Pub. Date: Jun. 4, 2015

(54) Executable-Based Platform Selection

(71) Applicant: John C. Leung, Folsom, CA (US)

(72) Inventor: John C. Leung, Folsom, CA (US)

(21) Appl. No.: 14/094,260

(22) Filed: Dec. 2, 2013

(51) Int. Cl. H04L 12/24; G06F 9/45

(52) U.S. Cl. CPC H04L 41/04; G06F 8/41

(57) ABSTRACT

One embodiment provides a data center management system. The data center management system includes a data center manager module configured to select an executable application in response to a service request; and a platform selection module configured to select a platform of at least one platform based, at least in part, on application metadata and based, at least in part, on a platform capability.

### FIELD

The present disclosure relates to platform selection, and, more particularly, to executable-based platform selection.

### BACKGROUND

Software (application and/or operating system) vendors may typically compile source code into generic executable code configured to maximize the number of platforms (i.e., computing devices) capable of running the executable code. Compilation may thus be performed using a portion of available instructions, the portion configured to utilize a common subset of platform capabilities. While such a generic executable may be easier to maintain and may operate reliably across a number of platforms, the generic executable is unable to exploit available capabilities of a specific platform. Thus, advances, improvements and/or additions to platform capabilities may not be utilized resulting in less than optimal overall performance.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a functional block diagram of a platform selection system consistent with various embodiments of the present disclosure;

FIG. 2 illustrates a functional block diagram of one example of an application source consistent with various embodiments of the present disclosure;

FIG. 3 illustrates one example class schema consistent with various embodiments of the present disclosure.

FIG. 4 illustrates a functional block diagram of one example of a data center consistent with various embodiments of the present disclosure;

FIG. 5 is a flowchart of compiler operations according to various embodiments of the present disclosure;

FIG. 6 is a flowchart of data center management system operations according to various embodiments of the present disclosure; and

FIG. 7 is another flowchart of data center management system operations according to one embodiment of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure relates to executable-based platform selection methods (and systems) configured to select a platform to execute an application based, at least in part, on application metadata and, at least in part, on platform capabilities. As used herein, “platform” means a computing device such as a server that includes one or more processor(s), input/output (I/O) circuitry and memory, and is configured to execute one or more executable applications. Application metadata includes parameters related to target platform capabilities and may be utilized to support selection of a platform that has at least some of those capabilities.

A compiler may be configured to compile application source code based, at least in part, on one or more compiler option(s) related to platform capabilities. The compiler option(s) may be indicated, e.g., selected, by respective compiler flag(s). The compiler option(s) are configured to control and/or modify the behavior of the compiler and, thereby, optimization(s) of a resultant executable application. The resultant executable application(s) may then be configured to utilize and/or exploit one or more of the platform capabilities. Platform capabilities may include, but are not limited to capabilities related to, processor architecture (e.g., Intel x86, Intel IA-64, IBM AS/400, etc.), processor architecture extension(s) (e.g., VT-d, etc.), instruction set architecture(s) supported (e.g., 32-bit, 64-bit), instruction set extension(s) supported (e.g., parallel processing), physical architecture (e.g., number and type(s) of processor(s), memory configuration(s), I/O capabilities, bus structure, etc.), other circuitry available, special purpose and/or optional functionality available, e.g., special purpose processor(s), security feature(s), etc. Application source code may be compiled into a number of associated executable applications based, at least in part, on value(s) of the compiler flag(s). As used herein, “executable application” includes an operating system, a virtual machine monitor (i.e., hypervisor) and/or application executable code hosted by an operating system. Thus, one application source code may have a plurality of associated executable applications based, at least in part, on respective compiler flag(s) with each executable application configured to exploit one or more target platform capabilities.

In some embodiments, application metadata related to the compiler flag(s) may be generated. The application metadata is configured to include identifiers related to target platform capabilities and parameters related to whether the capability is required or desired. The parameters may be further configured to indicate a relative desirability between a plurality of capabilities. In some embodiments, the application metadata may be appended to the executable application so that the executable application includes the associated application metadata. In some embodiments, the application metadata may be associated with a respective application by, e.g., an association table.

The executable application(s) may then be provided to a data center for storage in a repository. In some embodiments, the application metadata (if any) may also be provided to the data center for storage in the repository. The data center may include a resource pool that includes operational platform(s). The data center may further include one or more dormant platform(s). The platform(s) may be configured to expose respective platform capabilities, e.g., in response to a query.

The data center may include a data center management system configured to manage operations of the data center. The data center management system may be configured to receive the executable applications (and application metadata, if any) and to store them in the repository. The data center management system may be configured to query the platforms for their respective capabilities. In some embodiments, the data center management system may be configured to generate application metadata for one or more of the executable applications, as described herein.

In operation, the data center management system may receive a service request from a service requestor. Based, at least in part, on the service request, the data center management system is configured to select an executable application and to then select one or more target platform(s) for executing the selected executable application based, at least in part, on the application metadata. The data center management system may then provision and instantiate the selected application on the selected platform(s).

Thus, consistent with the teachings of the present disclosure, a compiler may be configured to generate various executable applications from one source application based, at least in part, on compiler option(s), e.g., indicated by compiler flag(s). Respective application metadata related to target platform capabilities may be associated with and/or appended to each of the various executable applications. The application metadata may then be used by the data center management system to select a platform to execute an executable application based, at least in part, on platform capabilities. The executable application may then exploit the available platform capabilities.

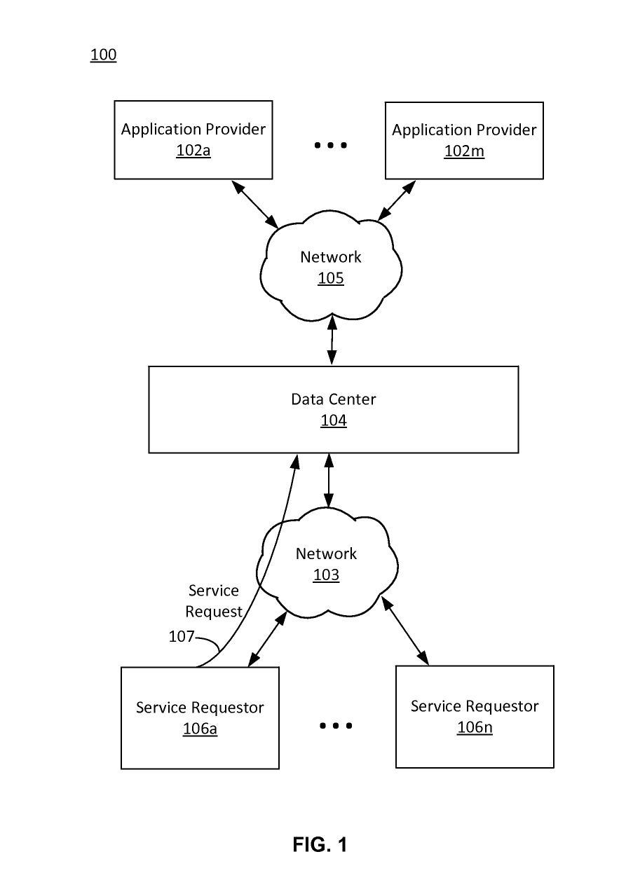

FIG. 1 illustrates a functional block diagram of a platform selection system 100 consistent with various embodiments of the present disclosure. Platform selection system 100 generally includes one or more application provider(s) 102a, . . . , 102m, a data center 104 and one or more service requestor(s) 106a, . . . 106n. The service requestor(s) 106a, . . . 106n may be coupled to data center 104 via a first network 103. The application provider(s) 102a, . . . , 102m may be coupled to data center 104 via a second network 105. In some embodiments, the first network 103 and the second network 105 may be the same network. An application provider, e.g., application provider 102a, is configured to compile application source code into one or more related executable applications based, at least in part, on one or more compiler flag(s). The application provider may be configured to generate application metadata related to each executable application, the application metadata generated based, at least in part, on the compiler flag(s). Application provider 102a may then be configured to provide the executable application to the data center 104. Application provider 102a may be further configured to provide the application metadata, if any, to the data center 104. The provided application metadata may be appended to or associated with the executable application, as described herein.

A service requestor, e.g., service requestor 106a is configured to provide a service request, e.g., service request 107, to the data center 104. In some situations, the service request 107 may include associated data and/or a pointer to associated data. The service request 107 is configured to include service functional requirements. In some embodiments, the service request 107 may include service operational requirements. The functional requirements and/or operational requirements may be embodied as service level objectives (SLO) within a service level agreement (SLA). Service functional requirements may include type of service (e.g., graphics processing, data processing and/or cryptographic operations), type of service interface, latency of a service request (i.e., latency between a service request and a start of execution of a selected application), a sustainable number and/or frequency of service requests, performance characteristics (e.g., processing speed, power consumption, reliability), etc. Service operational requirements may include an ability to monitor the service and/or resource utilization, e.g., power consumption, memory usage, etc. The service functional requirements may include ranges related to the characteristics, e.g., minimum speed and/or maximum power consumption, as well as nominal values associated with each characteristic. Data center 104 may be configured to select an executable application based, at least in part, on the service request 107. Data center 104 is configured to select a platform to host the executable application based, at least in part, on platform capabilities and application metadata. In some embodiments, the data center 104 may be further configured to select the platform based, at least in part, on the functional requirements.

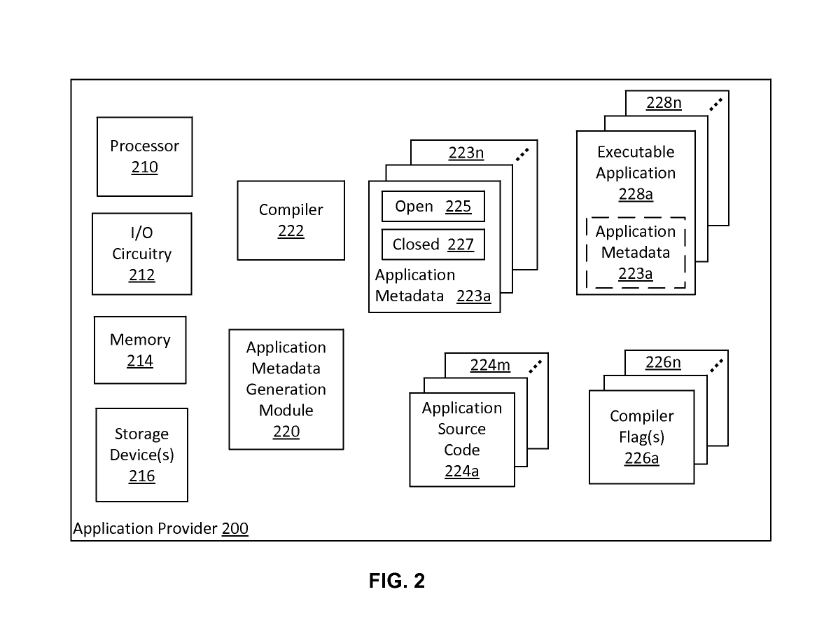

FIG. 2 illustrates a functional block diagram of an application provider 200, consistent with one embodiment of the present disclosure. The application provider 200 is one example of an application provider 102a, . . . 102m of FIG. 1. Application provider 200 includes a processor 210, input/output (I/O) circuitry 212, memory 214 and storage device(s) 216. Processor 210 may include one or more processing unit(s) and is configured to perform operations associated with application provider 200, as described herein. I/O circuitry 212 is configured to couple application provider 200 to data center 104 via, e.g., network 105. I/O circuitry 212 is configured to communicate over network 105 using one or more communication protocols.

Memory 214 is configured to store a application metadata generation module 220 and a compiler 222. Memory 214 may be configured to store one or more of application metadata 223a, . . . , 223n, application source code 224a, . . . , 224m, compiler flag(s) 226a, . . . , 226n, executable application 228a, . . . , 228n and/or portion(s) thereof. Application metadata generation module 220 may be included in compiler 222 or may be separate from, and accessible to, compiler 222, e.g., via a function call. In some embodiments, one or more of application metadata 223a, . . . , 223n, application source code 224a, . . . , 224m, compiler flag(s) 226a, . . . , 226n, executable application 228a, . . . , 228n and/or portions thereof may be included in storage device(s) 216.

Compiler 222 is configured to generate an executable application, e.g., executable application 228a, from application source code, e.g., application source code 224a, based, at least in part, on one or more compiler flag(s) 226a. The application source code 224a may be written in a high level programming language (e.g., C++ or Fortran). The executable application 228a is configured to execute on one or more platform(s) and may be configured to exploit one or more platform capabilities, as described herein. In some embodiments, compiler 222 may be configured to generate executable application 228a in memory 214, e.g., for later storage in storage device(s) 216. In another embodiment, compiler 222 may be configured to generate executable application 228a as a file, incrementally, in one or more of storage device(s) 216.

Compiler 222 may be configured to generate one or more versions of executable application 228a, . . . , 228n, depending on a respective state and/or value of the compiler flag(s) 226a, . . . , 226n. The compiler flag(s) 226a, . . . , 226n are configured to indicate to the compiler 222 whether to generate generic executable application or to implement instructions that rely on one or more target platform capabilities. The compiler 222 may then implement instructions that utilize the platform capabilities indicated by the compiler flag(s) 226a, . . . , 226n.

Application metadata generation module 220 is configured to generate application metadata related to the compiler flag(s), e.g., application metadata 223a related to compiler flag(s) 226a. Application metadata generation module may be configured to generate the application metadata 223a before, during or after generation of the executable application 228a by the compiler 222. In some embodiments, application metadata generation module 220 may be configured to generate application metadata 223a in memory 214, e.g., for later storage in storage device(s) 216. In another embodiment, application metadata generation module 220 may be configured to generate application metadata 223a as a file in one or more of storage device(s) 216. The application metadata 223a may then be associated with or appended to the executable application 228a that results from compiling the application source code, e.g., application source code 224a, based on the compiler flag(s) 226a.

The application metadata 223a is configured to indicate target platform capabilities that the executable application 228a is configured to use. Application metadata 223a may include identifier(s) related to platform capabilities. For example, each identifier may correspond to a respective platform capability. Application metadata, e.g., application metadata 223a, may include a plurality of types of application metadata, e.g., open application metadata 225 and closed application metadata 227. Open application metadata 225 is configured with a public, e.g., open standard, format that may then be freely accessible. Open application metadata 225 may comply or be compatible with the system management architecture for server hardware (“SMASH”) standard published by the Distributed Management Task Force, Inc. (DMTF) titled “SMASH Implementation Requirements”, version 2.0.0, published Aug. 20, 2009 and/or version 1.0.0, published Oct. 22, 2009, and/or later versions of these standards. Open application metadata 225 may comply or be compatible with a common interface model (“CIM”) schema, titled CIM Schema, version 2.35.1 published Apr. 6, 2013, by the DMTF. Schema are configured to provide model descriptions while the standard is configured to provide details related to integration with other management models.

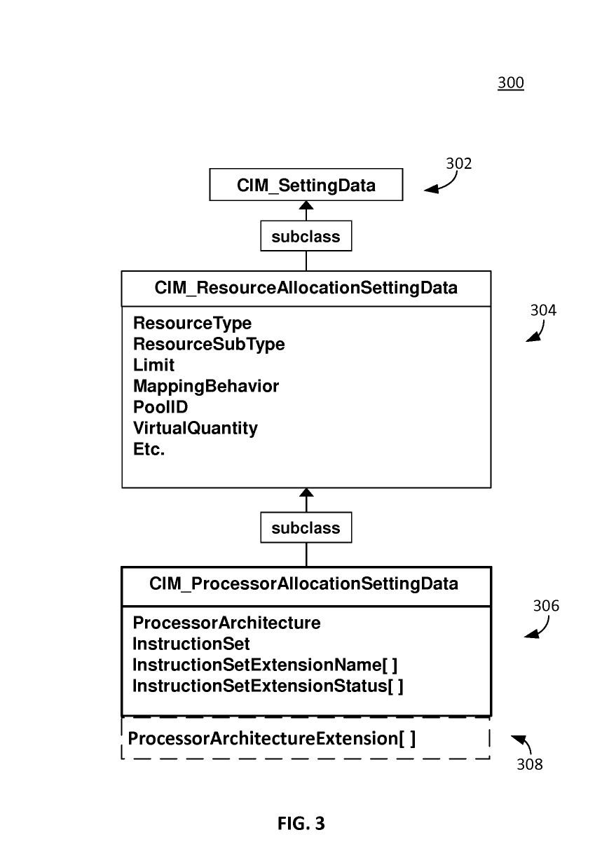

FIG. 3 illustrates one example class schema 300 consistent with various embodiments of the present disclosure. The illustrated class schema 300 includes class CIM_SettingData 302, subclass CIM_ResourceAllocationSettingData 304 and CIM_ProcessorAllocationSettingData 306 (a subclass of CIM_ResourceAllocationSettingData 304). Class CIM_ProcessorAllocationSettingData 306 includes properties ProcessorArchitecture, InstructionSet, InstructionSetExtensionName[ ] and InstructionSetExtensionStatus[ ]. Table 1 includes examples of text strings that these properties may contain. Property InstructionSetExtensionName[ ] is a vector and thus may include one or more entries. Table 1 illustrates InstructionSetExtensionName[ ] properties with one entry. InstructionSetExtensionName[ ] may include one or more of the instruction set extension related text strings. For example, for an Intel x86-compatible processor that is configured to execute SIMD (single instruction multiple data) instruction sets SSE2 and SSE3, the associated text string may be “DMTF:x86:SSE2, SSE3”.

TABLE 1

| [arch] | [instr-set] | [instr-set-ext][ ] |
|---|---|---|
| “DMTF:x86” | “DMTF:x86:i386” | “DMTF:x86:SSE2” |
| “DMTF:IA-64” | “DMTF:x86:i486” | “DMTF:x86:SSE3” |
| “DMTF:AS/400” | “DMTF:x86:i586” | “DMTF:x86:AVX” |
| “DMTF:Power” | “DMTF:x86:i686” | “DMTF:x86:MMX” |
| “DMTF:S/390” | “DMTF:x86:64” | . . . |
| “DMTF:PA-RISC” | “DMTF:IA-64:IA-64” | |
| “DMTF:ARM” | | |
| “DMTF:MIPS” | | |
| “DMTF:Alpha” | | |
| “DMTF:SPARC” | | |
| “DMTF:68k” | | |

Class CIM_ProcessorAllocationSettingData 306 may include property ProcessorArchitectureExtension[ ] 308 configured to identify processor attributes that may not be associated with an instruction, e.g., may be associated with virtualization. Example test strings for ProcessorArchitectureExtension[ ] formatted as [arch-ext][ ] may include, e.g., for an Intel x86-compatible processor, DMTF:x86:VT-d (virtualization capabilities related to partitioning I/O (e.g., including direct memory access and interrupt handling)), DMTF:x86:EPT (partitioning memory (e.g., extended page tables)) and/or DMTF:x86:SR-IOV (partitioning I/O devices (e.g., network adapter) between VMs.) For example, open application metadata 225 may include one or more text strings associated with one or more properties included in CIM_ProcessorAllocationSettingData 306. Open application metadata 225 may further include ProcessorArchitectureExtension[ ] 308. Thus, open application metadata 225 may include processor architecture identifiers and/or instruction set identifiers and may include associated extensions.

Closed application metadata 227 may include proprietary information that may be accessible only with permission, e.g., using a secret cryptographic key. For example, closed application metadata 227 may include identifiers related to processor features, package, chipset, hardware versions, steppings (e.g., hardware bug fixes), etc. Closed application metadata 227 may provide a relatively finer detail related to platform capabilities than open application metadata 225.

Application metadata 223a may further include identifiers related to platform physical capabilities. Physical capabilities may include, but are not limited to, number and type(s) of processor(s), memory configuration(s), I/O capabilities, bus structure, other circuitry available, special purpose and/or optional functionality available, e.g., special purpose processor(s), security feature(s), etc. Application metadata 223a may include settings related to physical capabilities. For example, some physical capabilities may not be accessible and/or may not function unless they are enabled. Thus, application metadata 223a may include a setting configured to enable a selected physical capability.

In some embodiments, the application metadata generation module 220 may be configured to include parameter(s) related to relative desirability of one or more of the platform capabilities in the application metadata 223a. For example, the parameter may be configured to indicate a relative importance of a capability, e.g., whether the capability is required, desired or a “don't care”. In another example, the parameter may be configured to indicate a relative desirability between a plurality of capabilities. The parameter may be based, at least in part, on one or more of the compiler flag(s) 226a. The application metadata generation module 220 is further configured to associate the application metadata 223a with or append the application metadata 223a to the respective executable application 228a. The executable application 228a and the application metadata 223a may then be provided to data center 104.

For example, application source code, e.g., application source code 224, may include graphics processing operations. A first version of an executable application may be generated by the compiler 222 based, at least in part, on a first compiler flag. The first compiler flag may be configured to direct the compiler 222 to include SIMD (single instruction-multiple data) instructions. A second version of an executable application may be generated by the compiler 222 based, at least in part, on the first and a second compiler flags. The second compiler flag may be configured to direct the compiler 222 to include instructions configured to be executed on a dedicated graphics processing unit. Thus, the first version of the executable application may be configured to execute on a platform that includes SIMD registers and an instruction set architecture that includes SIMD instructions. The second version of the executable application may be configured to execute on a platform that includes at least one of the dedicated graphics processing unit and the SIMD functionality.

Continuing with this example, a first version of application metadata may be appended to or associated with the first version of the executable application and a second version of application metadata may be appended to or associated with the second version of the executable application by application metadata generation module 220. The first version of application metadata is configured to indicate to, e.g., a data center management system, that a platform that includes SIMD registers and an instruction set architecture that includes SIMD instructions should be selected to execute the second version of the executable application, as described herein. The second version of application metadata is configured to indicate to, e.g., the data center management system, that a platform that includes at least one of the dedicated graphics processing unit and the SIMD capability should be selected, as described herein. The second version of the application metadata may further include parameters related to the graphics processing unit and the SIMD functionality, configured to indicate whether each is, for example, required or desired and/or which is relatively more desirable than the other.

Of course, graphics processing features are only one example of target platform capabilities that may be indicated by compiler flag(s) 226. Other target platform capabilities may be indicated based, at least in part, on the application source code 224 and related platform capabilities.

In another example, application source code, e.g., application source code 224, may include cryptographic operations. A third compiler flag may be configured to direct the compiler 222 to include instructions configured to implement encryption acceleration instructions and/or to ensure that selected cryptographic functions are executed on a secure processor and results are stored in secure storage. A third version of application metadata may be generated configured to indicate to, e.g., a data center management system, that a platform capable of executing encryption acceleration instructions and/or that includes a secure processor and secure storage should be selected to execute a third executable application, as described herein. The third version of application metadata may include parameter(s) that indicate that the encryption acceleration instruction capability and/or secure processor and secure storage are required target platform capabilities.

Thus, compiler 222 is configured to generate at least one executable application from application source code based, at least in part, on one or more compiler flag(s) 226a. In some embodiments, application metadata generation module 220 may be configured to generate application metadata 223a related to the compiler flag(s) 226a. The application metadata 223a is configured to indicate target platform capabilities that may be utilized by the executable application 228a during operation. The application metadata 223a may be used by, e.g., data center 104 to select a platform for hosting the executable application 228a.

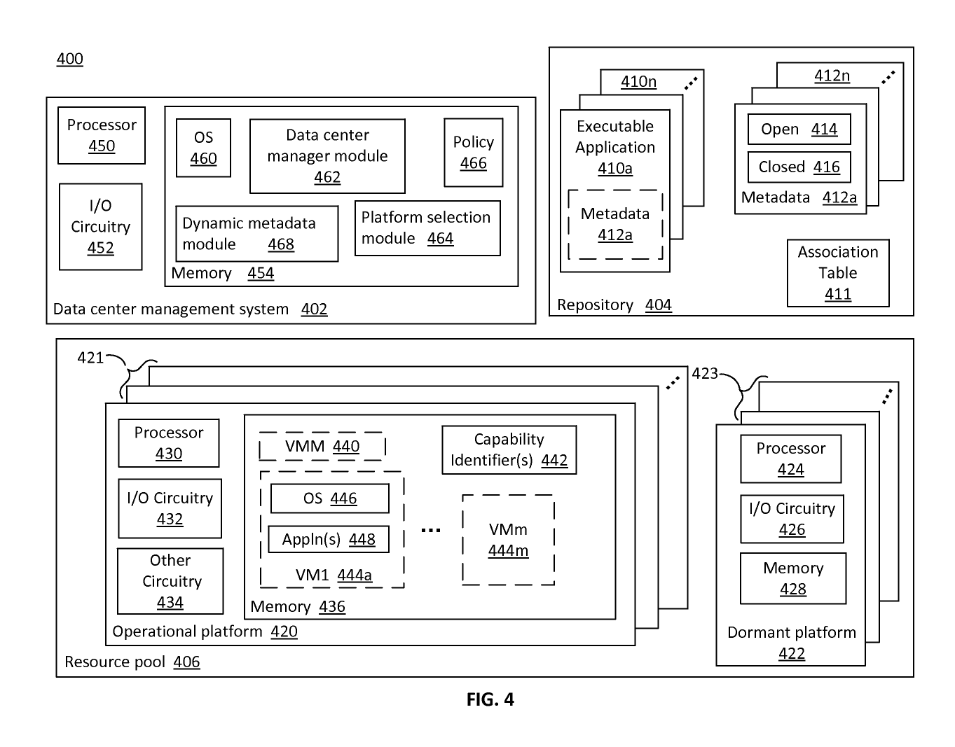

FIG. 4 illustrates a functional block diagram of a data center 400, consistent with one embodiment of the present disclosure. The data center 400 is one example of data center 104 of FIG. 1. Data center 400 includes a data center management system 402, a repository 404 and a resource pool 406. Data center management system 402 is configured to receive executable application(s) from application provider(s) 102a, . . . , 102m and to store the received executable application(s) in, e.g., repository 404. The received executable application(s) may or may not include appended application metadata. Data center management system 402 may receive associated application metadata and may store the associated application metadata in the repository 404. Data center management system 402 is configured to receive service request(s) related to executable application(s) and to select a platform from the resource pool 406 based, at least in part, on application metadata associated with the executable application(s) and based, at least in part, on platform capabilities.

Data center management system 402 includes processor 450, I/O circuitry 452 and memory 454. Processor 450 may include one or more core(s) (i.e., processing unit(s)) and is configured to perform operations associated with data center management system 402. I/O circuitry 452 is configured to couple data center 400 to an application provider, e.g., application provider 102a and a service requestor, e.g., service requestor 106a. Such coupling may be via network 103 and/or network 105 and I/O circuitry 452 may be configured to communicate over the networks 103, 105 using one or more communication protocols.

Memory 454 is configured to store an OS 460, a data center manager module 462 and a platform selection module 464. In an embodiment, memory 454 may be configured to store a policy 466. In an embodiment, memory 454 may be configured to store a dynamic metadata module 468.

Data center manager module 462 may be configured to receive one or more executable application(s) 410a, . . . , 410n from an application provider, e.g., application provider 102a and to store the executable application(s) 410a, . . . , 410n in repository 404. In some embodiments, application metadata may be appended to an executable application 410a, . . . , 410n. In some embodiments, data center manager module 462 may be configured to receive associated application metadata from application provider 102 and to store the associated application metadata in repository 404. In some embodiments, dynamic metadata module 468 may be configured to generate associated application metadata, as described herein. Thus, repository 404 is configured to store one or more executable application(s) 410a, . . . , 410n and respective application metadata 412a, . . . , 412n associated with each executable application 410a, . . . , 410n. For example, repository 404 may include one or more storage device(s), as described herein.

In some embodiments, e.g., for executable applications without appended application metadata and without associated application metadata, dynamic metadata module 468 may be configured to analyze an executable application, e.g., executable application 410a. Dynamic metadata module 468 may be configured to detect code fragments related to platform capabilities, e.g., related to processor architecture, instruction set, processor architecture extension and/or instruction set extensions. Such code fragments may correspond to a signature that may be utilized to generate associated application metadata. Using the signature, dynamic metadata module 468 is configured to identify one or more platform capabilities that the executable application 410a is configured to utilize. Dynamic metadata module 468 may then be configured to generate application metadata based, at least in part, on a result of the analysis. Whether an identified code fragment will actually execute may not be known to the dynamic metadata module 468. Thus, application metadata generated by dynamic metadata module 468 may be relatively less accurate than application metadata supplied by an application provider. Accuracy may be traded off for compiler complexity.

Application metadata generated by dynamic metadata module 468, e.g., application metadata 412a, may then be linked to the executable application 410a and stored in the repository 404. In some embodiments, application metadata 412a may be appended to executable application 410a. In some embodiments, the application metadata 412a may be associated with application 410a by, e.g., association table 411 configured to link each executable application 410a, . . . , 410n and its respective application metadata 412a, . . . , 412n. In some embodiments, dynamic metadata module 468 may be configured to generate the application metadata in response to data center 400 receiving the executable application. In some embodiments, dynamic metadata module 468 may be configured to generate the application metadata in response to a request (e.g., notice) from data center manager module 462. Application metadata, e.g., application metadata 412a, may include open application metadata 414 and/or closed application metadata 416, as described herein.

Resource pool 406 includes an operational platform 420 and may include a dormant platform 422. Resource pool 406 may include additional operational platform(s) 421 and additional dormant platform(s) 423. As used herein, an “operational platform” is a server that is executing at least one executable application and a “dormant platform” is a server that is not executing at least one executable application. A dormant platform may be completely quiescent, i.e., may be shutdown.

Operational platform 420 includes a processor 430 (that may include a plurality of processing units) and I/O circuitry 432 configured to couple operational platform 420 to data center management system 402 and/or to repository 404. I/O circuitry 432 may be further configured to couple platform 420 to a network, e.g., network 103. In some embodiments, I/O circuitry 432 may be utilized by an executable application, e.g., executable application 410a, to expose a service to data center management module 462 and thereby to a service requestor, e.g. service requestor 106a of FIG. 1. In some embodiments, operational platform 420 may include other circuitry 434. The other circuitry 434 may include, for example, a graphics processing unit, a math coprocessor, trusted platform module (TPM), processing accelerator(s), etc.

Operational platform 420 includes memory 436 configured to store operating system (OS) 446 and executable application(s) 448. In some embodiments, memory 436 may be configured to store a virtual machine monitor (i.e., hypervisor) 440 and one or more virtual machine(s) 444a, . . . , 444m. The hypervisor 440 is configured to manage one or more virtual machine(s) 444a, . . . 444m and their shared usage of operational platform 420 resources, e.g., processor 430, I/O circuitry 432 and/or other circuitry 434. Each virtual machine, e.g., virtual machine 444a, may include an operating system, e.g., OS 446, and at least one executable application, e.g., executable application(s) 448. The additional operational platform(s) 421, if any, may be configured similar to operational platform 420. The dormant platform 422 and additional dormant platform(s) 423, if any, include at least one processor 424, I/O circuitry 426 and memory 428. The dormant platform 422 and additional dormant platform(s) 423, if any, may further include other circuitry, a hypervisor, virtual machine(s), operating system(s) and/or capability identifier(s) (not shown). In other words, a dormant platform, if any, may include similar elements as an operational platform, e.g., operational platform 420, with the exception of an executable application.

Operational platform 420 is configured with one or more platform capabilities, as described herein. Operational platform 420 may include capability identifier(s) 442 configured to indicate platform capabilities. Respective capability identifiers may comply or be compatible with one or more CIM standard(s), e.g., SMASH Implementation Requirements and/or CIM Schema version 2.35.1, as described herein. Capability identifiers may correspond to the example class schema 300 of FIG. 3. Respective capability identifiers may comply or be compatible with an Intelligent Platform Management Interface (IPMI) specification. IPMI is a standardized computer system interface that may be used by system administrators for out-of-band management of computer systems and monitoring of their operation. For example, IPMI may be utilized to manage a computer that may be powered off or otherwise unresponsive. The IPMI specification may comply or be compatible with the IPMI specification version 2.0 published by Intel Corporation, Hewlett-Packard Company, NEC Corporation and Dell, titled Intelligent Platform Management Interface Specification, published Feb. 12, 2004 and/or later versions of this specification, for example, IPMI version 2.0 rev. 1.1, published Oct. 1, 2013. In an embodiment, capability identifier(s) 442 may include identifiers (e.g., text strings) related to processor architecture, instruction set, processor architecture extensions and/or instruction set extensions. The capability identifier(s) 442 may thus be related to properties 306 and/or 308 and may correspond to the text strings illustrated in Table 1.

For example, capability identifiers DMTF:x86, DMTF:x86:64, DMTF:x86[SSE2, SSE3, . . . ] are configured to indicate a platform, e.g., platform 420, that includes an Intel x86 architecture processor, e.g., processor 430, capable of operating in 64-bit mode that includes SIMD (single instruction, multiple data) capability. Platform selection module 464 may then be configured to select platform 420 (if platform 420 has available capacity) to host an executable application, e.g., executable application 410a, whose application metadata, e.g., application metadata 412a, indicates that the executable application 410a is configured to execute 64-bit and/or SIMD instructions on a processor compatible with an x86 processor architecture. For example, the application metadata may include the text strings: DMTF:x86, DMTF:x86:64, DMTF:x86[SSE2, SSE3, . . . ]

The capability identifier(s) 442 may be stored in memory 436 and/or included in circuitry, e.g., processor 430, I/O circuitry 432 and/or other circuitry 434. Similar to application metadata 412a, . . . , 412n, some capability identifiers may be open (i.e. freely accessible) and some capability identifiers may be closed (i.e. accessible only with permission). Operational platform 420 may be configured to expose capability identifier(s) 442 to data center manager module 462, e.g., in response to a request from data center manager module 462. The data center manager module 462 may then utilize the capability identifiers 442 to select a platform, as described herein.

Thus, resource pool 406 may include operational platform(s) and dormant platform(s). Each platform may be configured with respective platform capabilities that may then be exposed to data center manager module 462. The data center manager module 462 may then be configured to select one or more platform(s) to execute an executable application configured to use and/or exploit one or more of the platform and/or processor capabilities.

Data center manager module 462 is configured to manage a request for service from a service requestor, e.g., service request 107 from service requestor 106a. For example, the request for service 107 may include a request to host one or more executable application(s). Data center manager module 462 is configured to receive the request for service and to identify the executable application(s) to be hosted. Data center manager module 462 may be configured to retrieve the identified executable application(s) from repository 404. Data center manager module 462 may be configured to determine whether application metadata for each identified executable application exists in repository 404. Application metadata, if it exists, may be appended to and/or associated with an identified executable application, as described herein. If the application metadata does not exist, data center manager module 462 may be configured to notify dynamic metadata module 468. Dynamic metadata module 468 may then be configured to generate the application metadata, as described herein.

Platform selection module 464 is configured to select an available platform from the resource pool 406 to execute an executable application, e.g., executable application 410a, based, at least in part, on application metadata, e.g., application metadata 412a. Platform selection module 464 is configured to identify target platform capabilities utilized by, e.g., executable application 410a based, at least in part, on the application metadata 412a. Platform selection module 464 is configured to identify platform capabilities of platforms in the resource pool 406 using associated platform capability identifiers, e.g., capability identifier(s) 442. For example, platform selection module 464 may query platform 420 for its capabilities by reading capability identifiers 442. Platform selection module 464 may then compare the capability identifiers 442 with the target platform capabilities identified in application metadata 412a. If the capability identifiers 442 correspond to the identified target platform capabilities of the application metadata 412a and the platform 420 has capacity available, then the platform selection module 464 may be configured to provision and instantiate the executable application to platform 420. If platform 420 does not have available capacity and/or does not have sufficient target platform capabilities, then another platform in the resource pool 406 may be queried. If no platform is available, then the service requestor, e.g., service requestor 106a, may be notified that the service request cannot be satisfied.

In an embodiment, platform selection module 464 may be configured to determine whether a platform that meets at least a portion of the target platform capabilities identified in the application metadata is available. If a platform that meets at least a portion of the target platform capabilities identified in the application metadata is not immediately available, platform selection module 464 may be configured to determine whether a platform with the requested capabilities can be constructed and an amount of time required to construct the platform. In these embodiments, if the application metadata includes parameters related to whether a capability is required or desired, the platform selection module 464 may be configured to weight the capabilities based, at least in part, on whether the capability is required, desired or a don't care. The platform selection module 464 may be further configured to weight the capabilities against the time required to construct the platform, if a platform with the requested capabilities is not immediately available.

Policy 466 may include policies, e.g., rules, for weighting capabilities, weighting latencies and/or determining scores. A platform score may be determined based, at least in part, on a weighted percentage of requirements that are met, a weighted percentage of desired capabilities that are met, latency associated with a requested service becoming operational, impact on other operational services and/or a desired proximity of an executable application placement relative to operation of a service and/or a related executable application. For example, the percentage of requirements that are met may be weighted relatively higher than the percentage of desired capabilities that are met. In another example, capabilities that significantly affect performance may be weighted relatively higher than capabilities that have a relatively lesser effect on performance. In some embodiments, some policies may be related to, e.g., service functional requirements provided by the service requestor, e.g., service requestor 106a. Each platform with available capacity may then be scored based, at least in part, on weighted capabilities and the platform with a best score may then be selected to execute the application. In this manner, a platform that is a best match may be selected.

If an operational platform with capacity that satisfies the selection criteria is not available then a dormant platform, e.g., dormant platform 422, may be queried by, e.g., platform selection module 464 and/or data center manager module 462 to determine whether the dormant platform 422 may satisfy the selection criteria. If the dormant platform satisfies the selection criteria, whether the dormant platform 422 is activated may be based, at least in part, on policy 466. For example, a dormant platform that is fully quiescent, i.e., shutdown, may become operational after a delay. Policy 466 may include information regarding acceptable and unacceptable time intervals between a request for service and provisioning and instantiation of requested application(s). If the delay is within an acceptable time interval, then the dormant platform may be activated. If the delay is not within the acceptable time interval, then the service requestor 106a may be notified that the service request 107 cannot be satisfied.

The foregoing example embodiments are configured to generate executable application(s) from a source application based, at least in part, on compiler flag(s). The compiler flag(s) are configured to indicate target platform capabilities that may be utilized by the executable application. Application metadata related to the target platform capabilities may be generated and associated with or appended to the executable application. In response to a service request (e.g., to execute the executable application), a platform may then be selected based, at least in part, on the target platform capabilities as indicated by the application metadata and based, at least in part, on the platform's capability identifier(s). Platforms in a resource pool may be configured to expose their respective capabilities via, e.g., capability identifiers that may then be compared to the target platform capabilities. A “best” platform may then be selected for executing the executable application in response to the service request. Thus, improved performance may be achieved by exploiting platform capabilities rather than limiting functionality to only a common subset of platform capabilities.

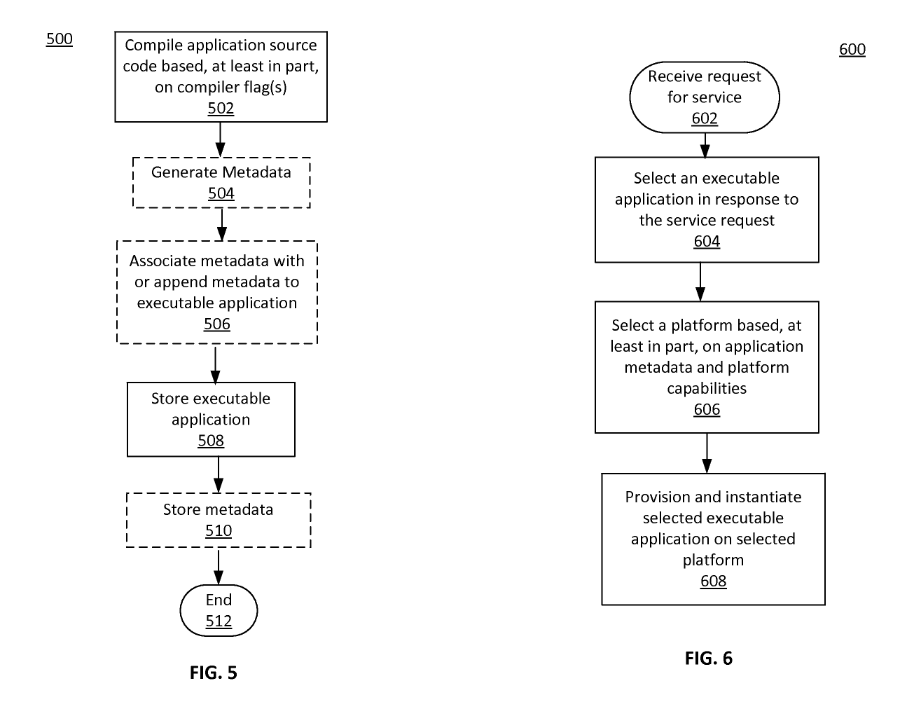

FIG. 5 is a flowchart 500 of compiler operations according to various embodiments of the present disclosure. In particular, the flowchart 500 illustrates generating an executable application from application source code based, at least in part, on one or more compiler flag(s). Operations of this embodiment include compiling application source code to generate an executable application based, at least in part, on one or more compiler flag(s) 502. The compiler flag(s) are configured to provide information related to target platform capabilities that the executable application may be configured to use. In some embodiments, application metadata may be generated at operation 504. In some embodiments, operation 502 and operation 504 may be performed concurrently. The application metadata is configured to include identifiers related to the target platform capabilities indicated by the one or more compiler flag(s). The application metadata may be associated with or appended to the generated executable application at operation 506. The executable application (that may include application metadata) may be stored at operation 508. In some embodiments, associated application metadata may be stored at operation 510. Program flow may end at operation 512.

The operations of flowchart 500 are configured to compile application source code to generate executable application based, at least in part, on compiler flag(s). The executable application is configured to utilize one or more platform capabilities indicated by the compiler flag(s). In some embodiments, application metadata based, at least in part, on the compiler flag(s) may be generated and associated with or appended to the executable application. The application metadata may then be utilized to select a platform that includes the platform capabilities indicated by the compiler flag(s).

FIG. 6 is a flowchart 600 of data center management system operations according to various embodiments of the present disclosure. In particular, the flowchart 600 illustrates selecting a platform to host an executable application based, at least in part, on application metadata and based, at least in part, on platform capabilities. The operations of flowchart 600 may be performed by, e.g., a data center management system. Operations of this embodiment begin with receiving a request for service 602. An executable application may be selected in response to the service request 604. For example, the executable application may be retrieved from a repository. Operation 606 includes selecting a platform based, at least in part, on application metadata associated with or appended to the retrieved application and one or more platform capabilities. The selected executable application may be provisioned and instantiated on the selected platform at operation 608.

The operations of flowchart 600 are configured to select a platform to host an executable application based, at least in part, on application metadata and platform capabilities. Thus, the executable application may be “matched” to the selected platform and may then exploit available platform capabilities.

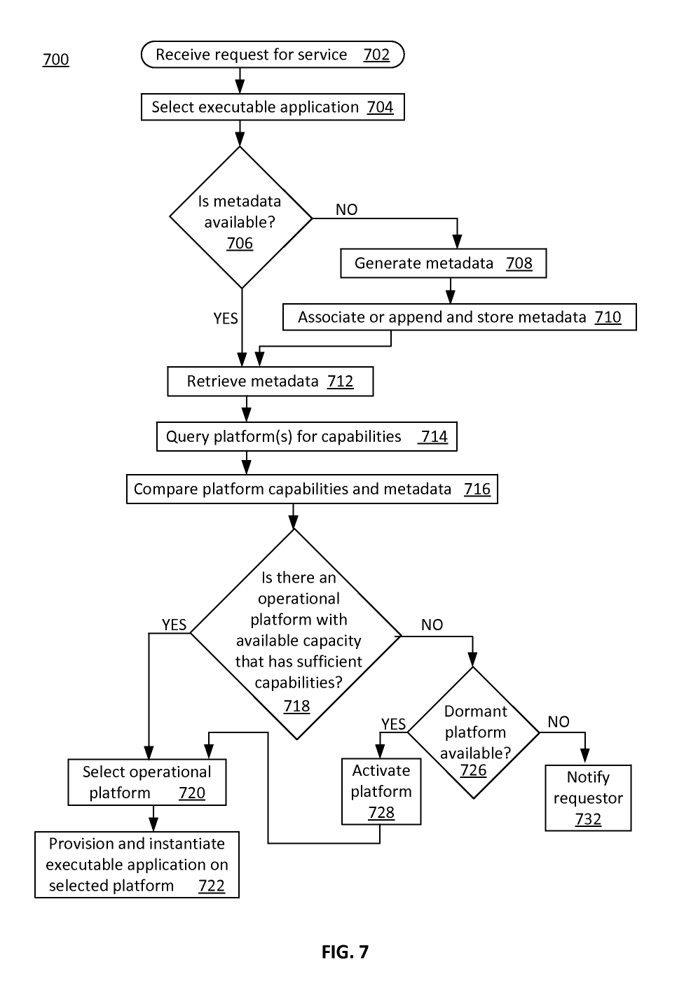

FIG. 7 is another flowchart of data center management system operations 700 according to one embodiment of the present disclosure. In particular, flowchart 700 illustrates one example of selecting a platform for executing an application based, at least in part, on platform capabilities. Operations of this embodiment include receiving a request for service from a service requestor 702. Operation 704 includes selecting an executable application related to the request for service. For example, the executable application may be retrieved from a repository. Whether application metadata, associated with the selected executable application exists, may be determined at operation 706. If the application metadata does not exist, operation 708 may include generating the application metadata. Operation 710 may then include associating the application metadata with or appending the application metadata to the executable application and storing the application metadata in the repository.

Application metadata may be retrieved from the repository at operation 712. Operation 714 includes querying platform(s) for their respective capabilities. For example, querying may include reading platform capability identifiers resident on the platform. For example, the platform capability identifiers may correspond to the properties illustrated in FIG. 3 and values listed in Table 1. Application metadata may be compared with platform capabilities at operation 716.

Whether an operating platform with available capacity exists that has sufficient capabilities may be determined at operation 718. In some embodiments, sufficient capabilities may include all of the target platform capabilities indicated by the application metadata. In some embodiments, sufficient capabilities may include a selected portion of the target platform capabilities indicated by the application metadata. Whether a respective platform's capabilities are sufficient may depend on a policy of the data center management system and/or functional requirements associated with the service request. If at least one operational platform with sufficient capabilities is available, an operational platform may be selected at operation 720. The executable application may then be provisioned and instantiated on the selected operational platform 722.

If such an operational platform is not available, whether a dormant platform with sufficient capability exists may be determined at operation 726. If a dormant platform with sufficient capability exists, the dormant platform may be activated at operation 728. Whether a dormant platform with sufficient capability is activated may depend on a policy of the data center management system and/or functional requirements (e.g., latency) related to the service request. Program flow may then proceed to operation 720 and the newly operational platform may be selected. If a dormant platform with sufficient capability does not exist, the requestor may be notified at operation 732.

The operations of flowchart 700 are configured to select a platform to host an executable application based, at least in part, on target platform capabilities identified in associated (or appended) application metadata and capability identifier(s) associated with a respective platform. If a platform with all of the target platform capabilities is not available, a platform with at least a portion of the target capabilities may be selected or the service requestor may be notified that the service request cannot be satisfied. Thus, an executable application configured to utilize one or more target platform capabilities may be provisioned and instantiated on a platform that includes a least a portion of the target platform capabilities.

Thus, consistent with the teachings of the present disclosure, a compiler may be configured to generate various executable applications from one source application based, at least in part, on compiler flag(s). Respective application metadata related to target platform capabilities may be associated with or appended to each of the various executable applications. The application metadata may then be used by a data center manager to select a platform to execute an executable application based, at least in part, on platform capabilities.

While the flowcharts of FIGS. 5, 6 and 7 illustrate operations according various embodiments, it is to be understood that not all of the operations depicted in FIGS. 5, 6 and/or 7 are necessary for other embodiments. In addition, it is fully contemplated herein that in other embodiments of the present disclosure, the operations depicted in FIGS. 5, 6 and/or 7, and/or other operations described herein may be combined in a manner not specifically shown in any of the drawings, and such embodiments may include less or more operations than are illustrated in FIGS. 5, 6 and/or 7. Thus, claims directed to features and/or operations that are not exactly shown in one drawing are deemed within the scope and content of the present disclosure.

The foregoing provides example system architectures and methodologies, however, modifications to the present disclosure are possible. For example, application source 200, data center management system 402, operational platform 420 and/or dormant platform 422 may also include chipset circuitry. Chipset circuitry may generally include “North Bridge” circuitry (not shown) to control communication between a processor, I/O circuitry and memory.

Application provider 200, data center management system 402, operational platform 420 and/or dormant platform 422 may each further include an operating system (OS) to manage system resources and control tasks that are run on each respective device and/or system. For example, the OS may be implemented using Microsoft Windows, HP-UX, Linux, or UNIX, although other operating systems may be used. In some embodiments, the OS may be replaced by a virtual machine monitor (or hypervisor) which may provide a layer of abstraction for underlying hardware to various operating systems (virtual machines) running on one or more processing units.

The operating system and/or virtual machine may implement one or more protocol stacks. A protocol stack may execute one or more programs to process packets. An example of a protocol stack is a TCP/IP (Transport Control Protocol/Internet Protocol) protocol stack comprising one or more programs for handling (e.g., processing or generating) packets to transmit and/or receive over a network. A protocol stack may alternatively be comprised on a dedicated sub-system such as, for example, a TCP offload engine and/or I/O circuitry. The TCP offload engine circuitry may be configured to provide, for example, packet transport, packet segmentation, packet reassembly, error checking, transmission acknowledgements, transmission retries, etc., without the need for host CPU and/or software involvement.

Application provider(s) 102a, . . . , 102m, data center 104 and/or service requestor(s) 106a, . . . , 106n may communicate with each other, via networks 103, 105, using a switched fabric communications protocol, for example, an Ethernet communications protocol, Infiniband communications protocol, etc. The Ethernet communications protocol may be capable of providing communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in March, 2002 and/or later versions of this standard, for example, the IEEE 802.3 Standard for Ethernet, published 2012. The Infiniband protocol may comply or be compatible with the Infiniband specification published by the InfiniBand Trade Association (IBTA), titled “InfiniBand™ Architecture Specification”, Volume 1, Release 1.2.1, published June 2001 and/or later versions of this specification, for example, InfiniBand™ Architecture, Volume 1 (General Specification), Release 1.2.1, published January 2008 and Volume 2 (Physical Specification), Release 1.3, published November 2012. Of course, in other embodiments, the switched fabric communications protocol may include a custom and/or proprietary switched fabric communications protocol.

Compiler 222 may be configured to generate one or more versions of an executable application from application source code based, at least in part, on one or more compiler flag(s). For example, compiler 222 may be implemented using an Intel C++ compiler or an Intel Fortran compiler, although other compilers may be used.

Memory 214, 454, 436, 428 and/or repository 404 may comprise one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may comprise other and/or later-developed types of computer-readable memory.

Embodiments of the operations described herein may be implemented in a system that includes one or more storage devices having stored thereon, individually or in combination, instructions that when executed by one or more processors perform the methods. The processor may include, for example, a processing unit and/or programmable circuitry. The storage device may include any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

“Circuitry”, as used in any embodiment herein, may comprise, for example, singly or in any combination, hardwired circuitry, programmable circuitry, state machine circuitry, and/or firmware that stores instructions executed by programmable circuitry. “Module”, as used herein, may comprise, singly or in any combination circuitry and/or code and/or instructions sets (e.g., software, firmware, etc.).

In some embodiments, a hardware description language may be used to specify circuit and/or logic implementation(s) for the various modules and/or circuitry described herein. For example, in one embodiment the hardware description language may comply or be compatible with a very high speed integrated circuits (VHSIC) hardware description language (VHDL) that may enable semiconductor fabrication of one or more circuits and/or modules described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

Thus, consistent with the teachings of the present disclosure, a compiler may be configured to generate various executable applications from one source application based, at least in part, on compiler flag(s). Respective application metadata related to target platform capabilities may be associated with or appended to each of the various executable applications. The application metadata may then be used by a data center management system to select a platform to execute an executable application based, at least in part, on platform capabilities. Thus, an executable application configured to utilize one or more platform capabilities may be provisioned and instantiated on a platform that includes at least some of those capabilities.

Accordingly, the present disclosure provides an example data center management system. The example data center management system includes a data center manager module configured to select an executable application in response to a service request; and a platform selection module configured to select a platform of at least one platform based, at least in part, on application metadata and based, at least in part, on a platform capability.

The present disclosure also provides an example data center. The example data center includes a repository configured to receive and store at least one executable application; a resource pool including at least one platform; and a data center management system. The data center management system includes a data center manager module configured to select one executable application of the at least one executable application in response to a service request; and a platform selection module configured to select one of the at least one platform based, at least in part, on application metadata and based, at least in part, on a respective platform capability.

The present disclosure also provides an example method. The example method includes selecting, by a data center manager module, an executable application in response to a service request; and selecting, by a platform selection module, a platform based, at least in part, on application metadata and based, at least in part, on a capability of the platform.

The present disclosure also provides an example system that includes one or more storage devices having stored thereon, individually or in combination, instructions that when executed by one or more processors result in the following operations including: selecting an executable application in response to a service request; and selecting a platform based, at least in part, on application metadata and based, at least in part, on a capability of the platform.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A data center management system, comprising:
a data center manager module configured to select an executable application in response to a service request; and
a platform selection module configured to select a platform of at least one platform based, at least in part, on application metadata and based, at least in part, on a platform capability.

2. The data center management system of claim 1, further comprising a dynamic application metadata module configured to generate the application metadata based, at least in part, on the selected executable application and to associate the application metadata with or append the application metadata to the selected executable application.

3. The data center management system of claim 1, wherein the platform selection module is configured to read a respective capability identifier exposed by each of the at least one platform, the respective capability identifier corresponding to the platform capability.

4. The data center management system of claim 3, wherein the platform capability comprises at least one of processor architecture, instruction set supported, instruction set extension supported and processor architecture extension.

5. The data center management system of claim 3, wherein the platform selection module is configured to compare the application metadata and the respective capability identifier for each of the at least one platform and to select the platform based, at least in part, on a result of the comparison.

6. A data center, comprising:
a repository configured to receive and store at least one executable application;
a resource pool comprising at least one platform; and
a data center management system comprising:
a data center manager module configured to select one executable application of the at least one executable application in response to a service request; and
a platform selection module configured to select one of the at least one platform based, at least in part, on application metadata and based, at least in part, on a respective platform capability.

7. The data center of claim 6, wherein the data center management system further comprises a dynamic application metadata module configured to generate the application metadata based, at least in part, on the selected executable application and to associate the application metadata with or append the application metadata to the selected executable application.

8. The data center of claim 6, wherein each platform is configured to expose a respective capability identifier corresponding to the respective platform capability, the respective platform capability comprising at least one of processor architecture, instruction set supported, instruction set extension supported and processor architecture extension.

9. The data center of claim 8, wherein the platform selection module is configured to compare the application metadata and the respective platform capability identifier for each platform and to select the one platform based, at least in part, on a result of the comparison.

10. The data center of claim 6, wherein the resource pool comprises at least one operational platform and at least one dormant platform and the platform selection module is configured to activate one of the at least one dormant platform if no operational platform with available capacity has sufficient platform capabilities related to the application metadata associated with or appended to the selected executable application.

11. A method, comprising:
selecting, by a data center manager module, an executable application in response to a service request; and
selecting, by a platform selection module, a platform based, at least in part, on application metadata and based, at least in part, on a capability of the platform.

12. The method of claim 11, further comprising:
generating, by a dynamic application metadata module or an application metadata generation module, the application metadata; and
associating, by the dynamic application metadata module or the application metadata generation module, the application metadata with the executable application or appending, by the dynamic application metadata module or the application metadata generation module, the application metadata to the executable application, the application metadata related to a target platform capability.

13. The method of claim 11, further comprising:
compiling, by an application provider, an application source code to generate the executable application based, at least in part, on a compiler flag, the compiler flag related to a target platform capability.

14. The method of claim 11, further comprising:
reading, by the platform selection module, a capability identifier exposed by the platform, the capability identifier corresponding to the capability of the platform, the platform capability comprising at least one of processor architecture, instruction set supported, instruction set extension supported and processor architecture extension; and
comparing, by the platform selection module, the application metadata and the capability identifier wherein the platform is selected based, at least in part, on a result of the comparison.

15. The method of claim 11, wherein the platform is dormant prior to the selecting and further comprising activating, by the platform selection module, the platform.

16. A system comprising, one or more storage devices having stored thereon, individually or in combination, instructions that when executed by one or more processors result in the following operations comprising:
selecting an executable application in response to a service request; and
selecting a platform based, at least in part, on application metadata and based, at least in part, on a capability of the platform.

17. The system of claim 16, wherein the instructions that when executed by one or more processors results in the following additional operations comprising:
generating the application metadata; and
associating the application metadata with the executable application or appending the application metadata to the executable application, the application metadata related to a target platform capability.

18. The system of claim 16, wherein the instructions that when executed by one or more processors results in the following additional operations comprising:
compiling an application source code to generate the executable application based, at least in part, on a compiler flag, the compiler flag related to a target platform capability.

19. The system of claim 16, wherein the instructions that when executed by one or more processors results in the following additional operations comprising:
reading a capability identifier exposed by the platform, the capability identifier corresponding to the capability of the platform, the platform capability comprising at least one of processor architecture, instruction set supported, instruction set extension supported and processor architecture extension; and
comparing the application metadata and the capability identifier wherein the platform is selected based, at least in part, on a result of the comparison.

20. The system of claim 16, wherein the platform is dormant prior to the selecting and the instructions that when executed by one or more processors results in the following additional operations comprising activating the platform.
